(19) United States
(12) Patent Application Publication
(10) Pub. No.: US 2003/0089206 A1
(43) Pub. Date: May 15, 2003

(54) Method of aligning a workpiece in a cutting machine

(76) Inventor: Tsuyoshi Ueno, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/289,409

(22) Filed: Nov. 7, 2002

(30) Foreign Application Priority Data
Nov. 9, 2001 (JP) 2001-344118

(51) Int. Cl. B26D 1/00; B26D 3/00

(52) U.S. Cl. 83/34

(57) ABSTRACT

A chucking means is positioned relatively with respect to a pair of cutting means in such a state that each of a pair of imaging means images at least part of the particular rectangular regions which are separated apart in the Y-axis direction on the surface of a workpiece. Positions of the particular parts in the particular rectangular regions on the X-axis and Y-axis are detected by processing the images obtained by each of the pair of imaging means through an image processing means. An angle θ of inclination of the street with respect to the X-axis or Y-axis is calculated based on the positions of the particular parts in the particular rectangular regions on the X-axis and Y-axis.

### FIELD OF THE INVENTION

The present invention relates to a method of aligning streets of a workpiece relatively with respect to a pair of cutting means prior to cutting, along the streets, the workpiece such as a semiconductor wafer having a plurality of rectangular regions are defined by the streets arranged in a lattice form on the surface thereof, in a cutting machine having a pair of cutting means each equipped with an imaging means.

### DESCRIPTION OF THE RELATED ART

In producing semiconductor chips, as is well known among people skilled in the art, a plurality of rectangular regions are sectioned by the streets arranged in a lattice form on the surface of the semiconductor wafer, and a semiconductor circuit is formed on each of the rectangular regions. The semiconductor wafer is cut along the streets to separate the rectangular regions individually. Each of the thus separated rectangular regions constitutes a semiconductor chip. A typical cutting machine (also called a dicer) for cutting the semiconductor wafer along the streets comprises a chucking means which is mounted to freely move in the X-axis direction that is substantially horizontal and to freely turn about the central axis extending in the Z-axis direction that is substantially vertical, a pair of cutting means which are mounted at a distance from each other in the Y-axis direction that is substantially horizontal, to freely move in the Y-axis direction, a pair of imaging means provided for each of the cutting means, an image processing means, and an arithmetic means. The semiconductor wafer to be cut is held on the chucking means. The semiconductor wafer is held on the chucking means with its angle that is mechanically aligned based on an orientation flat formed on the semiconductor wafer itself or based on a predetermined notch or the like formed in the frame when the semiconductor wafer has been mounted on the frame. However, the mechanical alignment of angle is not so precise and errors inevitably are involved in the mechanical alignment of angle to some extent (for example, in a range of about 1 to 2 degrees). More specifically, the streets of the semiconductor wafer are inclined with respect to the X-axis and Y-axis within a small angular range.

In the cutting machine of the above-mentioned type, therefore, at least part of the image of the rectangular region is imaged by the imaging means, the image processing means detects a position of a particular part of the image on the X-axis and Y-axis obtained by, for example, pattern matching, the chucking means is then moved in the X-axis direction by a predetermined distance and, thereafter, at least part of another rectangular region is imaged, the position of the particular part of the obtained image on the X-axis and Y-axis is detected, and the angle of inclination of the street with respect to the X-axis and Y-axis is calculated based on the positions of the particular part on the X-axis and Y-axis of before and after the chucking means is moved in the X-axis direction. The chucking means is turned by an angle of inclination that has been detected, to correct the inclination of the street with respect to the X-axis and Y-axis.

However, the above conventional method of aligning the workpiece such as the semiconductor wafer (correcting the angle of inclination) involves a problem in that a relatively long time is required since the chucking means must be moved in the direction of X-axis for detecting the angle of inclination of the workpiece.

### SUMMARY OF THE INVENTION

It is a principal object of the present invention to provide a method of aligning a workpiece in the cutting machine of the above-mentioned type, which makes it possible to shorten the required time to a considerable degree as compared to that of the prior art.

The present inventor has directed his attention to the fact that a pair of cutting means in the cutting machine of the above-mentioned type are each provided with an imaging means and hence, a pair of imaging means exist in the cutting machine, and has found that the angle of inclination of the workpiece can be detected in a relatively short time without the need of moving a chucking means in the X-axis direction by detecting positions of particular parts in the rectangular regions in the respective images obtained by the pair of imaging means and calculating the angle of inclination of the workpiece based on the positions of the two particular parts.

Namely, according to the present invention, as a method of aligning a workpiece in a cutting machine that accomplishes the above-mentioned principal object, there is provided a method of aligning a workpiece in a cutting machine comprising a chucking means which is mounted to freely move in the X-axis direction and to freely turn about the central axis that extends in the Z-axis direction, a pair of cutting means which are mounted at a distance from each other in the Y-axis direction to freely move in the Y-axis direction, a pair of imaging means provided for each of the cutting means, an image processing means, and an arithmetic means, the method of aligning the workpiece having a plurality of rectangular regions defined by the streets arranged in a lattice form on the surface thereof and held on the chucking means, which comprises aligning the streets of the workpiece held on the chucking means relatively with respect to the pair of cutting means prior to cutting the workpiece along the streets by causing the pair of cutting means to act on the workpiece while moving the chucking means in the X-axis direction, wherein:

the chucking means is positioned relatively with respect to the pair of cutting means in such a state that each of the pair of imaging means images at least part of the respective two particular rectangular regions which are separated apart in the Y-axis direction on the surface of the workpiece;

positions of the particular parts in the particular rectangular regions on the X-axis and Y-axis are detected by processing the images obtained by each of the pair of imaging means through the image processing means;

the angle θ of inclination of the street with respect to the X-axis and Y-axis is calculated based on the positions of the particular parts in the particular rectangular regions on the X-axis and Y-axis; and

the chucking means is turned by the angle θ of inclination to compensate the inclination of the street with respect to the X-axis and Y-axis.

Preferably, further, a deviation in the Y-axis direction between the acting positions of the pair of cutting means and the street is calculated based on the positions of the particular parts on the X-axis and Y-axis, and the deviation in the Y-axis direction between the acting positions of the pair of cutting means and the street is compensated by moving the pair of cutting means in the Y-axis direction after the chucking means has been turned by the angle θ of inclination. In a preferred embodiment, the workpiece is a semiconductor wafer, the rectangular regions are all furnished with a semiconductor circuit, and the image processing means detects the particular parts by pattern matching. Each of the pair of cutting means is allowed to move in the Z-axis direction, and has a rotary cutting blade which rotates about a common central axis of rotation that extends in the Y-axis direction.

### BRIEF DESCRIPTION OF THE DRAWINGS

FIG. 1 is a perspective view illustrating part of the cutting machine to which is adapted an aligning method of the present invention;

FIG. 2 is a block diagram of a control means that is provided for the cutting machine of FIG. 1;

FIG. 3 is a perspective view illustrating a workpiece (a semiconductor wafer mounted on a frame via a mounting tape) to be cut by the cutting machine of FIG. 1;

FIG. 4 is a partial plan view illustrating part of the surface of the semiconductor wafer; and

FIG. 5 is a diagram schematically illustrating a procedure for alignment.

### DETAILED DESCRIPTION OF THE PREFERRED EMBODIMENTS

A preferred embodiment of the present invention will now be described in further detail with reference to the accompanying drawings.

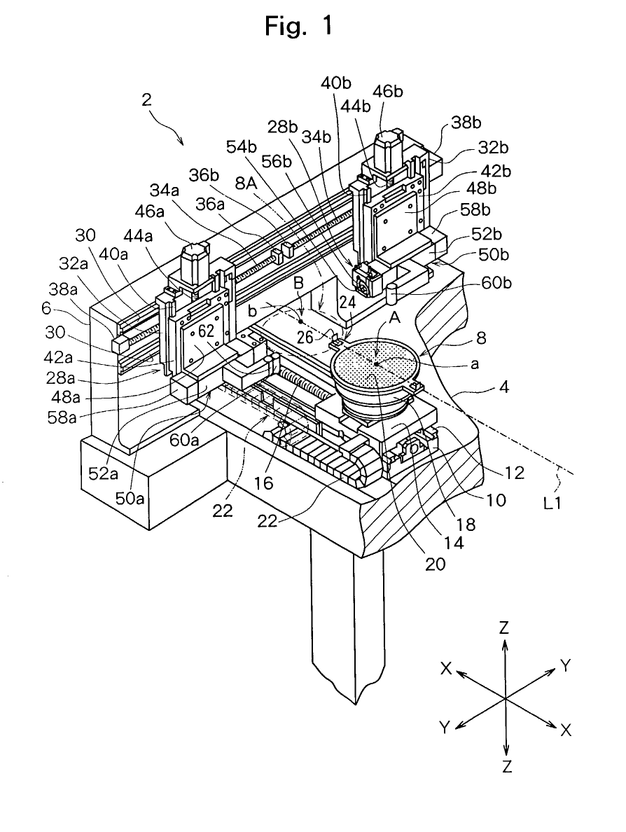

FIG. 1 is a view illustrating part of the cutting machine to which the aligning method of the present invention can be applied. The illustrated cutting machine 2 comprises a stationary support plate 4 extending substantially horizontally. On the support plate 4 are arranged a chucking zone A and a cutting zone B, and a line L1 extends in the back-and-forth direction passing through the center a of the chucking zone A and the center b of the cutting zone B. On the support plate 4 is further arranged an upright support board 6 at the rear portion thereof extending in the direction of width. For convenience in this specification, the back-and-forth direction is referred to as the X-axis direction, the direction of width is referred to as the Y-axis direction, and the vertical direction is referred to as the Z-axis direction.

With further reference to FIG. 1, a chucking means 8 is arranged on the support plate 4 to move between the chucking zone A and the cutting zone B in the X-axis direction. Specifically, a pair of support blocks 10 (only one of them is illustrated in FIG. 1) are secured on the support plate 4 at a distance in the X-axis direction. A pair of guide rails 12 are secured between the pair of support blocks 10 extending in the X-axis direction maintaining a distance in the Y-axis direction. A slide block 14 is mounted on the pair of guide rails 12. Further specifically, a pair of to-be-guided grooves (not shown) are formed in the lower surface of the slide block 14 extending in the X-axis direction. With the pair of to-be-guided grooves being engaged with the pair of guide rails 12, the slide block 14 is mounted being allowed to freely move along the guide rails 12 in the X-axis direction. An externally threaded shaft 16 extending in the X-axis direction is rotatably mounted between the pair of support blocks 10. On the other hand, an internally threaded member (not shown) is secured to the lower surface of the slide block 14, and meshes with the externally threaded shaft 16. An electric motor (not shown) is coupled to the externally threaded shaft 16, and the slide block 14 is moved in the X-axis direction along the guide rails 12 depending upon whether the electric motor is driven forward or reverse.

A cylindrical support member 18 is secured to the slide block 14, and mounts a chucking member 20 of the shape of a disk so that it turns about the central axis which extends substantially in the vertical direction, i.e, in the Z-axis direction. The support member 18 is provided with a source of rotary drive (not shown) which may be an electric motor for turning the chucking member 20. The slide block 14 is provided with a hollow protection duct 22 which is deformed suitably between a state indicated by a solid line in FIG. 1 and a state indicated by a two-dot chain line depending upon the movement of the slide block 14. The chucking member 20 formed of a porous material such as porous ceramic is selectively communicated with a suitable suction source (not shown) through a suction passage (not shown) arranged through the slide block 14 and through the hollow protection duct 22. The chucking member 20 is further provided with a pair of grip mechanisms 24 which protrude in the X-axis direction. Each of the grip mechanisms 24 has a movable grip piece 26 which is selectively brought, by an operation means (not shown) such as an air actuator, to a non-gripping position shown in FIG. 1 and to a gripping position moved inward from the non-gripping position. The electric wiring for a means for moving the movable grip pieces 26 of grip mechanisms 24 runs also through the support member 18, slide block 14 and hollow protection duct 22.

With further reference to FIG. 1, the support board 6 mounts a pair of cutting means, i.e., the first cutting means 28a and the second cutting means 28b. If detailedly described, a pair of guide rails 30 are arranged on the inner surface of the support board 6 extending in the Y-axis direction at a distance in the Z-axis direction. A pair of to-be-guided grooves (not shown) extending in the Y-axis direction are formed in the outer surface of a slide block 32a of the first cutting means 28a and in the outer surface of a slide block 32b of the second cutting means 28b. With the pair of to-be-guided grooves being engaged with the pair of guide rails 30, the slide block 32a and the slide block 32b are mounted on the pair of guide rails 30 so as to slide in the Y-axis direction. Externally threaded shafts 34a and 34b extending in the Y-axis direction are rotatably mounted through bearing members 36a and 36b in front of the support board 6. The externally threaded shafts 34a and 34b are arranged on a straight line. Internally threaded members (not shown) are secured to the back surfaces of the slide blocks 32a and 32b, and each of them is meshed with each of the externally threaded shafts 34a and 34b. Electric motors 38a and 38b are connected to the externally threaded shafts 34a and 34b. When the externally threaded shafts 34a and 34b are rotated by the electric motors 38a and 38b, the slide blocks 32a and 32b move in the Y-axis direction along the pair of guide rails 30. Further, a pair of guide rails 40a and 40b are arranged, at a distance in the Y-axis direction, on the front surfaces of the slide blocks 32a and 32b extending in substantially the vertical direction, i.e., extending in the Z-axis direction. A pair of to-be-guided grooves extending in the Z-axis direction are formed in the outer surfaces of lift blocks 42a and 42b. With the pair of to-be-guided grooves being engaged with the pair of guide rails-40a and 40b, the lift blocks 42a and 42b are mounted on the slide blocks 32a and 32b so as to move up and down in the Z-axis direction. Further, externally threaded shafts 44a and 44b extending in the Z-axis direction are rotatably mounted on the slide blocks 32a and 32b. On the other hand, internally threaded members (not shown) are secured to the back surfaces of the lift blocks 42a and 42b, and each of them is meshed with the respective externally threaded shafts 44a and 44b. Shafts 46a and 46b of electric motors are coupled to the externally threaded shafts 44a and 44b, and the lift blocks 42a and 42b move up and down along the guide rails 40a and 40b in the Z-axis direction depending upon whether the electric motors 46a and 46b are driven forward or reverse.

Cutting units 50a and 50b are mounted on the respective lift blocks 42a and 42b via coupling brackets 48a and 48b. The cutting units 50a and 50b have casings 52a and 52b of nearly a rectangular parallelopiped shape. Rotary shafts (FIG. 1 shows the rotary shaft 54b only that is mounted on the casing 52b) extending in the Y-axis direction are rotatably mounted on the casings 52a and 52b. Cutting blades (FIG. 1 shows the cutting blade 56b only that is secured to the rotary shaft) are secured to the inner ends, i.e., the facing ends of the rotary shafts. The cutting blades can be constituted by thin disks containing diamond grinder particles. Electric motors 58a and 58b are connected to the outer ends of the rotary shafts.

The first cutting means 28a is provided with first imaging means 60a and additional imaging means 62, and the second cutting means 28b is provided with second imaging means 60b. Stated specifically, the first imaging means 60a and the additional imaging means 62 are attached on the casing 52a of the first cutting means 28a having a cutting blade (not shown). Therefore, when the electric motor 38a rotates causing the first cutting means 28a to move in the Y-axis direction, the first imaging means 60a and the additional imaging means 62, too, move in the Y-axis direction with the movement of the first cutting means 28a. Further, when the electric motor 46a rotates causing the lift block 42a of the first cutting means 28a to move in the Z-axis direction, the first imaging means 60a and the additional imaging means 62, too, move in the Z-axis direction with the movement of the lift block 42a. Accordingly, a positional relationship remains the same at all times among the cutting blade (not shown) of the first cutting means 28a, the first imaging means 60a and the additional imaging means 61. Similarly, the second imaging means 60b is attached on the casing 52b of the second cutting means 28b having the cutting blade 56b. Therefore, when the electric motor 38b rotates causing the second cutting means 28b to move in the Y-axis direction, the second imaging means 60b, too, moves in the Y-axis direction with the movement of the second cutting means 28b. Further, when the electric motor 46b rotates causing the lift block 42b of the second cutting means 28b to move in the Z-axis direction, the second imaging means 60b, too, moves in the Z-axis direction with the movement of the lift block 42b. Therefore, a positional relationship remains the same at all times between the cutting blade 56b of the second cutting means 28b and second imaging means 60b.

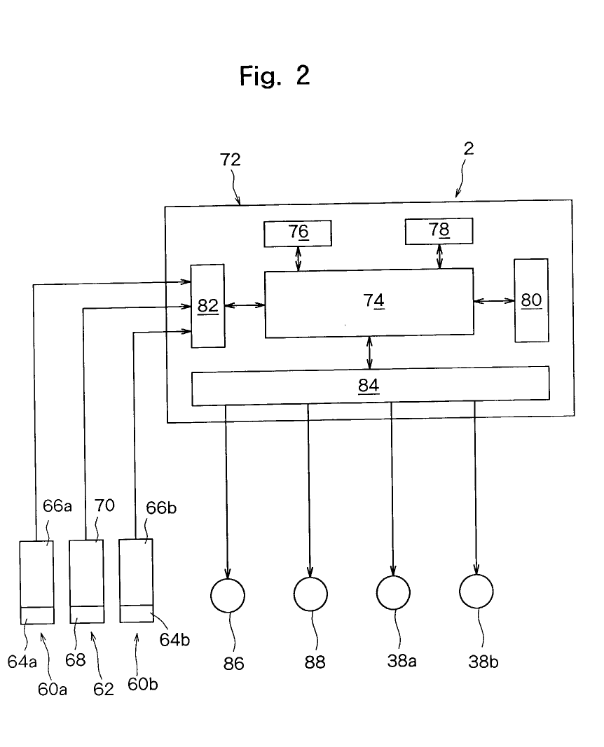

With reference to FIG. 2, the first imaging means 60a has a microscope 64a of a relatively large magnification and an imaging unit 66a which may be a CCD, and the second imaging means 60b, too, has a microscope 64b of a relatively large magnification and an imaging unit 66b which may be a CCD. On the other hand, the additional imaging means 62 has a microscope 68 of a relatively low magnification and an imaging unit 70 which may be a CCD.

FIG. 2 further illustrates a control means 72 possessed by the cutting machine 2 which is constituted as described above. The control means 72 comprises a central processing unit 74 (which constitutes the image processing means as well as the arithmetic means) which executes an image processing and an arithmetic operation according to a control program, a read-only memory 76 for storing the control program and the like, an image frame memory 78 for storing the image obtained through the first imaging means 60a, second imaging means 60b and additional imaging means 62, a key pattern memory 80, an input interface 82 which may be an A/D converter, and an output interface 84. The input interface 82 of the thus constituted control means 72 receives signals from the first imaging means 60a, second imaging means 60b and additional imaging means 62. The output interface 84 sends control signals to an electric motor 86 (not shown in FIG. 1) for moving the chucking means 8 in the X-axis direction, an electric motor 88 (not shown in FIG. 1) for turning the chucking member 20 about the central axis extending in the Z-axis direction, an electric motor 38a for moving, in the Y-axis direction, the first cutting means 28a on which the first imaging means 60a and the additional imaging means 62 are attached, and an electric motor 38b for moving, in the Y-axis direction, the second cutting means 28b on which the second imaging means 60b is attached.

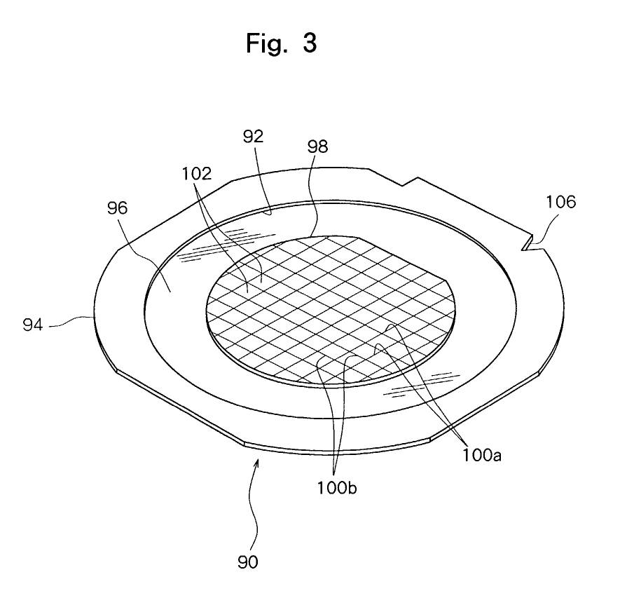

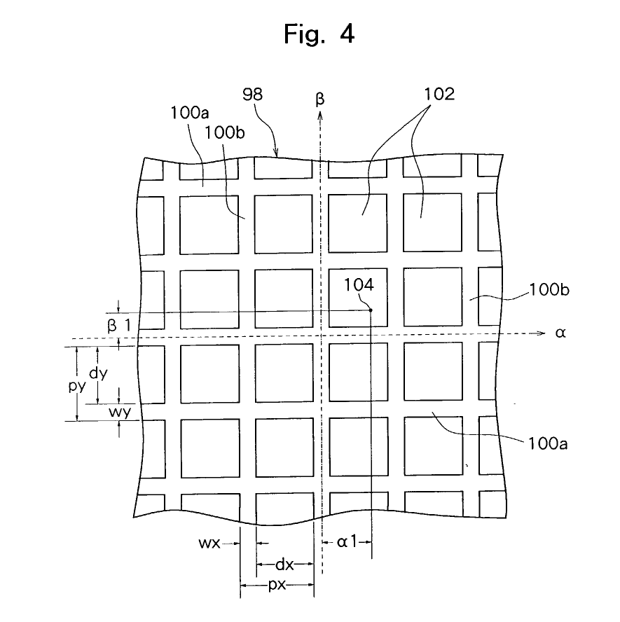

FIGS. 3 and 4 illustrate a workpiece 90 that is to be cut by the above cutting machine 2. In the illustrated embodiment, the workpiece is a semiconductor wafer 98 mounted, via a mounting tape 96, on a frame 94 that has a mounting opening 92 formed in the central portion thereof. There are a plurality of streets 100a and 100b arranged in a lattice form on the surface of the semiconductor wafer 98. In FIG. 4, the streets 100a extend in the right-and-left direction, have a predetermined width wy and are arranged at a predetermined distance dy. In FIG. 4, further, the streets 100b extend in the up-and-down direction, have a predetermined width wx and are arranged at a predetermined distance dx (here, the predetermined width wx and the predetermined width wy may not always be substantially the same but may often be different from each other and, similarly, the predetermined distance dx and the predetermined distance dy may not always be substantially the same but may often be different from each other). On the surface of the semiconductor wafer 98, therefore, a plurality of rectangular regions 102 are sectioned by the streets 100a and 100b arranged at a pitch px=wx+dx in the right-and-left direction in FIG. 4 and at a pitch py=wy+dy in the up-and-down direction in FIG. 4. And, the same semiconductor circuit is applied to each of the rectangular regions 102, and a key pattern exists at a particular part 104 of each of the rectangular regions 102 to be imaged by the imaging means 60a and 60b at the time of alignment that will be described later. Referring to FIG. 4, if the center line of the street 100a is regarded as an α-axis and the center line of the street 100b as a β-axis, the particular part 104 can be represented as coordinate values (α1, β1) on the α-β coordinate system. The key pattern and the β-coordinate value β1 of the particular part 104 at which the key pattern exists, are used at the time of alignment that will be described later and are, hence, stored in advance in the key pattern memory 80 in the control means 72. As shown in FIG. 3, on the other hand, a notch 106 is formed at a predetermined position of the frame 94 of the workpiece 90, and the direction in which the notch 106 extends is related to the directions in which the streets 100a and 100b of the semiconductor wafer 98 mounted on the frame 94 extend.

A step of cutting the workpiece 90 by the cutting machine 2 will now be described with reference to FIG. 1 as well as FIGS. 2 and 3. While the chucking means 8 is positioned in the chucking zone A shown in FIG. 1, the workpiece 90 is place on the chucking member 20 by a feed means that is not shown. At this moment, the semiconductor wafer 98 of the workpiece 90 is placed on the chucking member 20 within a range of a required error though it is not sufficiently precise (in which either the street 100a or 100b of the workpiece 90 may be inclined at an angle θ which is not greater than about ±1.5 to 3.0 degrees with respect to the Y-axis direction) based on the notch 106 formed in the frame 94. Then, the chucking member 20 is communicated with the suction source (not shown), whereby the semiconductor wafer 98 of the workpiece 90 is adsorbed on the chucking member 20. At the same time, the movable grip pieces 26 of the pair of grip mechanisms 24 attached to the chucking member 20 are brought to the gripping position to grip the frame 94 of the workpiece 90. Then, the chucking means 8 moves in the X-axis direction up to the position indicated by the two-dot chain line 8A in FIG. 1. At this position, the semiconductor wafer 98 on the chucking member 20 is aligned at a sufficiently high precision with respect to the cutting blade (not shown) of the first cutting means 28a and the cutting blade 56b of the second cutting means 28b. The aligning method will be described later in detail.

Thereafter, the chucking means 8 moves to the cutting zone B where the semiconductor wafer 98 adsorbed by the chucking member 20 is subjected to the dicing. During the dicing, the chucking member 20 is caused to move in the X-axis direction, whereby the cutting blade (not shown in FIG. 1) of the first cutting means 28a and the cutting blade 56b of the second cutting means 28b act on the semiconductor wafer 98 simultaneously or with some time lag to cut the semiconductor wafer 98 along either the street 100a or 100b extending in the X-axis direction. The cutting unit 50a of the first cutting means 28a and the cutting unit 50b of the second cutting means 28b are caused to move in the Z-axis direction and are brought to a predetermined height, and are periodically index-moved in the Y-axis direction (the pitch py of the street 100a and the pitch px of the street 100b have been stored in advance in the read-only memory 76, and the control means 72 causes to index-move the slide block 32a of the first cutting means 28a and the slide block 32b of the second cutting means 28b in the Y-axis direction in accordance with the pitches py and px). When the cutting along either the street 100a or 100b extending in the X-axis direction is completed, the chucking member 20 is turned by 90 degrees and then, the cutting starts along either the street 100a or 100b which newly located in a state of extending in the X-axis direction. As described above, the semiconductor wafer 98 on the chucking member 20 is cut along the streets 100a and 100b arranged in a lattice form. Thereafter, the chucking means 8 moves to the chucking zone A shown in FIG. 1. The chucking member 20 is then separated away from the suction source (not shown), whereby the semiconductor wafer 98 is released from adsorption by the chucking member 20, and the movable grip pieces 26 of the pair of grip mechanisms 24 attached to the chucking member 20 are returned back to the non-gripping positions, whereby the frame 94 is released from gripping. Thereafter, the semiconductor wafer 98 is moved to a suitable place by a conveying means that is not shown.

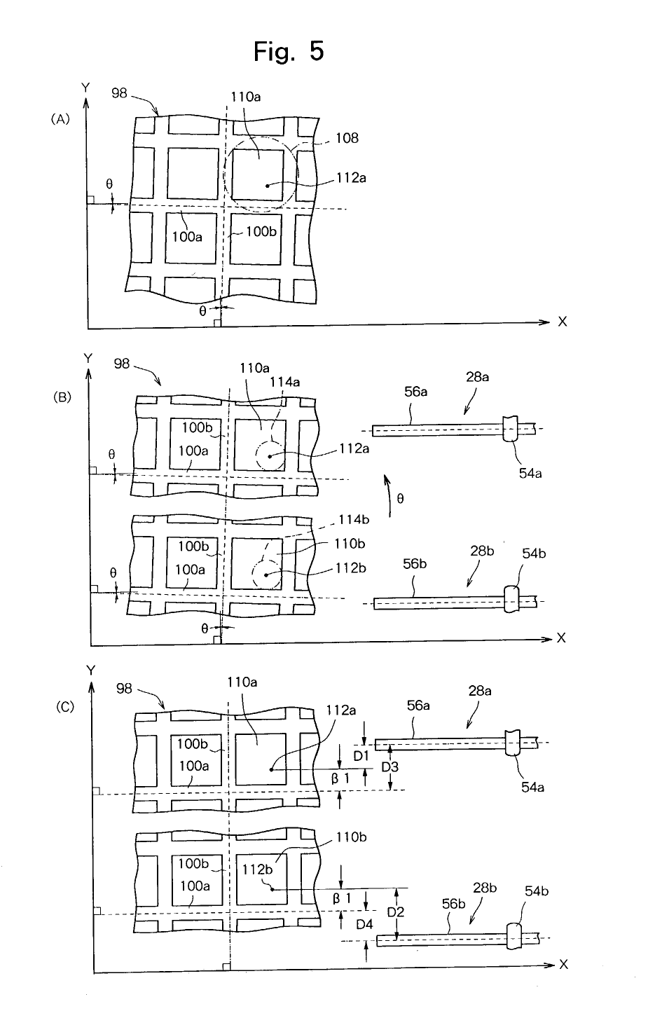

Described below is an embodiment of the aligning method with reference to FIG. 1 as well as FIGS. 2 and 5. The first cutting means 28a is first brought to a position where the additional imaging means 62 images the range indicated by a two-dot chain line 108 in FIG. 5(A), i.e., images a range including at least a particular rectangular region 110a on the surface of the semiconductor wafer 98. Then, the particular rectangular region 110a is imaged by the additional imaging means 62. The image obtained by the additional imaging means 62 is captured by the image frame memory 78 through the input interface 82 and the central processing unit 74. Thereafter, the central processing unit 74 executes the pattern matching of the image captured by the image frame memory 78 with the key pattern that has been stored in advance in the key pattern memory 80. This makes it possible to detect the position of a particular part 112a of the particular rectangular region 110a with a relatively rough accuracy.

Next, the first cutting means 28a is brought to a position where the first imaging means 60a images the range indicated by a two-dot chain line 114a in FIG. 5(B), i.e., images a range including at least the particular part 112a of the particular rectangular region 110a. Further, based on the detected position of the particular part 112a, the second cutting means 28b is brought to a position where the second imaging means 60b images the range indicated by a two-dot chain line 114b in FIG. 5(B), i.e., images a range including at least a particular part 112b of the particular rectangular region 110b which is separated away in the Y-axis direction from the particular rectangular region 110a by an integral multiple of the pitch py. Then, the particular part 112a is imaged by the first imaging means 60a and the particular part 112b is imaged by the second imaging means 60b. The images obtained by the first imaging means 60a and the second imaging means 60b are captured by the image frame memory 78 through the input interface 82 and central processing unit 74. Thereafter, the central processing unit 74 executes the pattern matching of the image captured by the image frame memory 78 with the key pattern that has been stored in advance in the key pattern memory 80. This makes it possible to detect the position of the particular part 112a in the particular rectangular region 110a with a relatively high accuracy and to detect the position of the particular part 112b in the particular rectangular region 110b with a relatively high accuracy.

With further reference to FIG. 1 as well as FIGS. 2 and 5(B), when the positions of the particular parts 112a and 112b are detected with a relatively high accuracy, then, the angle θ of inclination of the street 100a with respect to the X-axis direction (or of the street 100b with respect to the Y-axis direction) is obtain by using coordinate values (x1, y1) of the particular part 112a in the particular rectangular region 110a in the X-Y coordinate system and the coordinate values (x2, y2) of the particular part 112b in the particular rectangular region 110b in the X-Y coordinate system. Namely, the angle θ of inclination of the street 100a with respect to the X-axis direction (or of the street 100b with respect to the Y-axis direction) can be obtained from the following equation (1),

θ=tan⁻¹[(x1−x2)/(y1−y2)] (1)

The formula (1) has been stored in advance in the read-only memory 76 in the control means 72. Therefore, the central processing unit 74 in the control means 72 calculates the angle θ of inclination of the street 100a with respect to the X-axis direction (or of the street 100b with respect to the Y-axis direction) by using the coordinate values (x1, y1) of the particular part 112a in the particular rectangular region 110a and the coordinate values (x2, y2) of the particular part 112b in the particular rectangular region 110b. The control means 72, then, controls the electric motor 88 based on the calculated angle θ of inclination, whereby the chucking member 20 to which the electric motor 88 is coupled is turned by the angle θ of inclination to compensate the inclinations of the streets 100a and 100b on the surface of the semiconductor wafer 98 with respect to the X-axis and Y-axis directions.

In the aligning method of the present invention as described above, it is allowed to detect the angle θ of inclination within a relatively short time since there is no need of moving the chucking means 20 in the X-axis direction for detecting the angles θ of inclination of the streets 100a and 100b on the surface of the semiconductor wafer 98 with respect to the X-axis and Y-axis directions.

Next, with further reference to FIGS. 1, 2, 5(B) and 5(C), the Y-coordinate values of the particular parts 112a and 112b after the chucking member 20 has been turned by the angle θ of inclination to adjust the angle are obtained by using the coordinate values (x1, y1) of the particular part 112a in the particular rectangular region 110a in the X-Y coordinate system, the coordinate values (x2, y2) of the particular part 112b in the particular rectangular region 110b in the X-Y coordinate system and the value y0 of Y-coordinate of the central axis of the chucking member 20. Namely, the Y-coordinate value y3 of the particular part 112a after the angle has been adjusted by turning it by the angle θ of inclination can be found from the following equation (2), and the Y-coordinate value y4 of the particular part 112b after the angle has been adjusted by turning it by the angle θ of inclination can be obtained from the following equation (3),

$$\begin{matrix}y3 = y0 - \frac{( x1 - x0 ) ( x2 - x1 ) + ( y1 - y0 ) ( y2 - y1 )}{\sqrt{{( y2 - y1 )}^{2} + {( x2 - x1 )}^{2}}} & ( 2 ) \\ y4 = y0 - \frac{( x2 - x0 ) ( x2 - x1 ) + ( y2 - y0 ) ( y2 - y1 )}{\sqrt{{( y2 - y1 )}^{2} + {( x2 - x1 )}^{2}}} & ( 3 )\end{matrix}$$

Next, when the calculated Y-coordinate value y3 of the particular part 112a after the angle has been adjusted is used, since the positional relationship between the first imaging means 60a and the cutting blade 56a of the first cutting means 28a remains constant at all times, the central processing unit 74 in the control means 72 can obtain a deviation D1 in the Y-axis direction between the particular part 112a after the angle has been adjusted and the center line of the cutting blade 56a of the first cutting means 28a in the X-axis direction by storing the positional relationship in the read-only memory 76 of the control means 72 in advance. Similarly, when the calculated Y-coordinate value y4 of the particular part 112b after the angle has been adjusted is used, since the positional relationship between the second imaging means 60b and the cutting blade 56b of the second cutting means 28b remains constant at all times, the central processing unit 74 in the control means 72 can find a deviation D2 in the Y-axis direction between the particular part 112b after the angle has been adjusted and the center line of the cutting blade 56b of the second cutting means 28b in the X-axis direction by storing the positional relationship in the read-only memory 76 of the control means 72 in advance.

With further reference to FIGS. 2 and 5(C), the central processing unit 74 in the control means 72 finds a deviation D3 in the Y-axis direction between the center line of the cutting blade 56a of the first cutting means 28a in the X-axis direction and the center line of the street 100a on the surface of the semiconductor wafer 98 by using the β coordinate value β1 of the particular part 112a (see FIG. 4) and the deviation D1 in the Y-axis direction between the particular part 112a after the angle has been adjusted and the center line of the cutting blade 56a of the first cutting means 28a in the X-axis direction. Further, the central processing unit 74 in the control means 72 finds a deviation D4 in the Y-axis direction between the center line of the cutting blade 56b of the second cutting means 28b in the X-axis direction and the center line of the street 100a on the surface of the semiconductor wafer 98 by using the β coordinate value β1 of the particular part 112b (see FIG. 4) and the deviation D2 in the Y-axis direction between the particular part 112b after the angle has been adjusted and the center line of the cutting blade 56b of the second cutting means 28b in the X-axis direction. Thereafter, the control means 72 controls the electric motor 38a based on the deviation D3 that has been calculated. Thereby, the first cutting means 28a is moved in the Y-axis direction by D3, and the center line of the cutting blade 56a in the direction of the rotary shaft 54a is positioned on the center line of the street 100a on the surface of the semiconductor wafer 98. The control means 72, further, controls the electric motor 38a based on the deviation D4 that has been calculated. Thereby, the second cutting means 28b is moved in the Y-axis direction by D4, and the center line of the cutting blade 56b in the direction of the rotary shaft 54b is positioned on the center line of the street 100a on the surface of the semiconductor wafer 98. Thus, the street 110a on the surface of the semiconductor wafer 98 can be aligned with respect to the cutting means 28a and 28b.

Though a preferred embodiment of the present invention was described above in detail with reference to the accompanying drawings, it should be noted that the present invention is in no way limited to the above embodiment only but can be changed and modified in a variety of other ways without departing from the scope of the invention.

What I claim is:

1. A method of aligning a workpiece in a cutting machine comprising a chucking means which is mounted to freely move in the X-axis direction and to freely turn about the central axis that extends in the Z-axis direction, a pair of cutting means which are mounted at a distance from each other in the Y-axis direction to freely move in the Y-axis direction, a pair of imaging means provided for each of the cutting means, an image processing means, and an arithmetic means, the method of aligning the workpiece having a plurality of rectangular regions defined by the streets arranged in a lattice form on the surface thereof and held on said chucking means, which comprises aligning the streets of the workpiece held on said chucking means with respect to said pair of cutting means prior to cutting the workpiece along the streets by causing said pair of cutting means to act on the workpiece while moving said chucking means in the X-axis direction, wherein:
said chucking means is positioned relatively with respect to said pair of cutting means in such a state that each of said pair of imaging means images at least part of the two particular rectangular regions which are separated apart in the Y-axis direction on the surface of said workpiece;
positions of the particular parts of said particular rectangular regions on the X-axis and Y-axis are detected by processing the images obtained by each of said pair of imaging means through said image processing means;
the angle θ of inclination of said street with respect to the X-axis and Y-axis is calculated based on the positions of the particular parts of said particular rectangular regions on the X-axis and Y-axis; and
said chucking means is turned by said angle θ of inclination to compensate the inclination of said street with respect to the X-axis and Y-axis.

2. An aligning method according to claim 1, wherein a deviation in the Y-axis direction between the acting positions of said pair of cutting means and said street is calculated based on the positions of said particular parts on the X-axis and Y-axis, and the deviation in the Y-axis direction between the acting positions of said pair of cutting means and said the street is compensated by moving said pair of cutting means in the Y-axis direction after said chucking means has been turned by said angle θ of inclination.

3. An aligning method according to claim 1, wherein said workpiece is a semiconductor wafer, said rectangular regions are all furnished with a semiconductor circuit, and said image processing means detects said particular parts by pattern matching.

4. An aligning method according to claim 1, wherein each of said pair of cutting means is allowed to move in the Z-axis direction, and has a rotary cutting blade which rotates about a common central axis of rotation that extends in the Y-axis direction.
